(19) United States
(12) Patent Application Publication
(10) Pub. No.: US 2010/0132748 A1
(43) Pub. Date: Jun. 3, 2010

(54) MOBILE DOSING SYSTEM

(76) Inventors: Arnd Kessler, Monheim-Baumberg (DE); Salvatore Fileccia, Oberhausen (DE); Michael Paton, Hertfordshire (GB); David Cross, Letchworth (GB)

Correspondence Address: Henkel Corporation, 10 Finderne Avenue, Bridgewater, NJ, 08807, US

(21) Appl. No.: 12/562,541

(22) Filed: Sep. 18, 2009

Related U.S. Application Data
(63) Continuation of application No. PCT/EP2008/050667, filed on Jan. 22, 2008.

(30) Foreign Application Priority Data
Mar. 22, 2007 (DE) 10 2007 014 425.5

(51) Int. Cl. B08B 3/00

(52) U.S. Cl. 134/93; 68/12.18; 68/17 R

(57) ABSTRACT

Mobile release and dosing system, particularly for preparations containing washing or cleaning agents, comprising at least one receptacle for receiving at least one first product capable of flow or dispersion, wherein the receptacle has at least one release opening which is arranged in such a way that a release of the product by gravity from the receptacle is effected in the operational position of the release system; a control apparatus which can be coupled with the release opening of the receptacle and which drives a dosing and release of at least the first flow or dispersion-capable product from the receptacle into the surrounding area. Said control apparatus comprises at least one sensor which detects physical and/or chemical properties and/or the material condition of the surrounding area of the sensor, measured either qualitatively or quantitatively; a control unit which transforms the signals of the sensor into at least one control signal usable for an actuator by means of at least one control program stored in the control unit; an actuator which transforms a control signal of the control unit into a different output quantity with which an object is moved or caused to move, wherein the actuator affects at least one dispenser directly or indirectly; at least one dispenser which is affected directly or indirectly by the actuator, wherein as a result of this influence, the opening and/or the closing of the release opening of the receptacle is effected; at least one energy source which supplies at least the control unit and the actuator with a suitable form of energy.

### CROSS REFERENCE TO RELATED APPLICATIONS

The present application is a continuation of International Application No. PCT/EP2008/050667, filed Jan. 22, 2008, which claims the benefit of German Patent Application No. DE 10 2007 014 425.5, filed Mar. 22, 2007.

The present invention relates to a mobile dispensing and dosing system for dispensing free flowing or dispersible preparations, in particular for preparations containing laundry detergents or cleaning compositions, into washing machines, washer dryers or the like.

The accurate and needs-required dosing of active substances is relevant in a number of applications. Dosing active substances, in particular in the domestic context, is becoming more important and leads the way by being based on accurate and needs-required dosage of appropriate active substances. In this respect, the environment is preserved due to the conservation of resources and avoidance of incorrect and over dosing, and secondly, the efficiency of the active substances dosed in this way is optimized.

Nowadays cleaning compositions for automatic dishwashers are frequently in tablet form. While their use and dosing is comparatively simple and convenient for the consumer, still, the release of the active substance from the tablets is not optimized in regard to the rinsing and drying cycles of the particular dishwasher.

Dosing devices for dispensing cleaning compositions during cleaning cycles of an automatic dishwasher are known, for example, from International Publication No. WO 2006/021764. Here the cleaning composition is dispensed and controlled by means of a bimetal element that on reaching a predefined temperature actuates a spring mechanism that releases the cleaning compositions into the automatic dishwasher.

A significant disadvantage of this dosing device is its complicated mechanical construction, thereby resulting in high manufacturing costs. Consequently, it is desirable to provide a dosing device with a mechanical configuration that is as simple as possible.

Moreover, the device taught in WO 2006/021764 is not suitable for releasing preparations in liquid or gel form. This would, however, be particularly advantageous, as it is usually the case that higher concentrations of active substances can be realized in liquids or gels than in solid presentation forms, such as powders or tablets.

For single flush-type dosing (often called one-shot), as is most often the case today, for example, with laundry detergent or cleaning tablets, it can happen that when feeding these types of surfactant preparations, for example in the course of a cleaning cycle of a dishwasher, the preparations, immediately after having been dosed into the dishwasher interior and on contact with water, become covered by layers of gel that then also impede a quick dissolution of the preparation encased by the layer of gel. This effect is all the more pronounced the greater the dosed amount that is flushed in, and the colder the water in which the preparation is to dissolve.

This can lead to gelled residues of the preparation remaining in the machine or on the dishes at the end of the cleaning program. Further, an insufficient amount of surfactant may be released during cleaning, thereby effecting a satisfactory cleaning performance of the preparation, particularly in low temperature washing and cleaning programs.

Accordingly, a dosing device is all the more desirable that releases surfactant mixtures that tend to gel whereby any gelling is prevented as far as possible, or is at least significantly reduced.

For this it is also required that these types of preparation be released at a defined temperature such that the preparation quickly and completely dissolves in the warm cleaning water.

Accordingly, there is a need to overcome the disadvantages from the prior art and to provide a dispensing and dosing device that releases a defined dose of a free flowing or dispersible product in a simple and controlled manner.

This can be achieved by a dispensing and dosing device that has the features of claim 1.

### BRIEF DESCRIPTION OF THE DRAWINGS

FIG. 1 is a schematic block diagram of a dosing unit according to the present invention.

FIG. 2 is a cross sectional view of a container and control module of a dosing unit according to the present invention.

FIG. 3 illustrates a cross sectional view of another embodiment of a container for a dosing unit according to the present invention.

FIG. 4 illustrates a cross sectional view of another embodiment of a container for a dosing unit according to the present invention.

FIG. 5 is a schematic drawing of a product release mechanism according to the present invention with the dispenser 12 in the open position.

FIG. 6 is a schematic drawing of a product release mechanism according to the present invention with the dispenser 12 in the closed position.

FIG. 7 is a schematic drawing of another embodiment of a product release mechanism according to the present invention with the dispenser 12 in the open position.

FIG. 8 is a schematic drawing of another embodiment of a product release mechanism according to the present invention with the dispenser 12 in the closed position.

FIG. 9 is a schematic drawing of another embodiment of a dosing system according to the present invention wherein the dosing chamber 15 has two sections 15a, 15b.

FIG. 10 is a flow diagram of a program for executing the control unit 9 of a dosing system according to the present invention.

FIG. 11 is a flow diagram of a program for controlling the positions of actuators in a dosing system according to the present invention.

FIG. 12 is a flow diagram of a program for controlling the positions of actuators in a two-container dosing system according to the present invention.

In the context of this application, “mobile” means that the dispensing and dosing system is not non-detachably connected with a device such as an automatic dishwasher, washing machine, washer dryer or the like, but rather can be removed for example from an automatic dishwasher or can be placed in an automatic dishwasher.

A significant advantage of the invention is that the dosing device is separated into a control unit and a container that can be coupled to the control unit, with the result that the control unit can be flexibly used for the most different applications.

As the dosing device does not use a mechanical control element for product release like that of the spring-bimetal system known from the prior art and described above, the dosing device can be miniaturized so that it can be also employed in applications wherein the size of the dosing device is critical, such as in dishwasher dosing or even in toilet flushes.

Energy sources, a control unit, a sensor unit, as well as at least one actuator and applicator can be integrated in the dosing appliance for driving the dosing device. The dosing appliance preferably includes a housing that is impervious to water splashes and which prevents the ingress of water into the interior of the dosing appliance, as can occur, for example, when the dosing device according to the invention is used in an automatic dishwasher.

In order to enable operation at higher temperatures that occur, for example, in the individual wash cycles of an automatic dishwasher, the dosing device can be molded from materials that are dimensionally stable up to a temperature of 120° C.

As the pH of the preparations to be dosed can be between 2 and 12, depending on the intended use, all components of the dosing device that come into contact with the preparations should be appropriately resistant to acid and alkali media. Moreover by choosing suitable materials, these components should be as far as possible chemically inert towards, for example, non-ionic surfactants, enzymes and/or fragrances.

It is particularly advantageous to seal the energy source, the control unit and the probe unit in such a way that the dosing appliance is essentially watertight, meaning, the dosing appliance can also operate when completely immersed in liquid. Exemplary casting resins that can be used are multi-component epoxy and acrylate casting compounds such as methacrylate esters, urethane methacrylates and cyanacrylates, or two-component materials containing polyurethanes, silicones and epoxy resins.

Encapsulation of the components in a suitably designed, moisture tight housing represents an alternative or complement to casting.

### Container

In the context of this application, the term “container” is understood to mean a package or receptacle that is suitable for encasing or holding together free-flowing or dispersible preparations, and can be coupled with a control unit for dispensing the preparation.

In particular, a container can also comprise a plurality of chambers or containers that can be filled up independently of each other with different preparations. It is also conceivable that a number of containers can be disposed in one unit, for example, into a cartridge.

The container advantageously possesses at least one outlet that is arranged such that the product can be released by gravity from the container in the operating state of the dispensing system. This ensures that additional means of conveyance for releasing the product out of the container are not needed, resulting in a dosing device which is simple in design and inexpensive in production costs.

In a preferred development of the invention, at least one additional container for receiving at least one additional free-flowing or dispersible product is provided. This additional container can possess at least one outlet arranged such that the product can be released by gravity from the container in the operating state of the dispensing system. The existence of a second container is particularly advantageous when preparations which are not usually storage stable together, such as bleaching agents and enzymes, are stored separately in the independent containers.

Moreover, it is also conceivable to provide more than two, especially three to four containers in the dispensing and dosing system. For example, a container can be designed to dispense fragrance into the surroundings.

In a further embodiment of the invention, the containers are integrally formed. In this way the containers can be made in a cost-effective manner in one production step, especially by an appropriate blow molding process. The containers can be connected together by ties or material bridges, for example.

It is also conceivable to mold the containers in a plurality of parts such that at least one container, preferably all containers, can be individually removed from the dosing device or can be individually placed into the dosing device. In this manner, when consumption of one product from one container differs from the consumption from another container, an emptied container can be exchanged, whereas the others that may still be full or partially full remain in the dosing unit. Thus, a selected and as-needed refill of the individual containers and their products can be carried out.

The multi-part designed containers can be fixed together by means of suitable connecting techniques, thereby forming a container unit. The containers can be fixed detachably or non-detachably to each other by an interlocking, friction locked and/or material joined connection. For example, the connection can be made by one or more of a variety of connections, such as snap-in connections, Velcro® fasteners, press-fitted assemblies, fused joints, adhesive joints, welded joints, soldered joints, screw connections, key joints, clamp joints and press stud connections. In particular, the connection can be formed by a shrink sleeve that, in a heated state, is at least partially pulled over the containers and, when cooled, strongly envelops the containers.

In order to provide advantageous residual emptying features to the container, the floor of the container can be in the shape of a funnel inclined towards the outlet. Further, by choice of suitable materials and/or surface characteristics, the interior wall of the container can be made so that the product exhibits low material adhesion to the interior container wall. This technique further optimizes the emptying of the remaining product from the container.

The containers can have the same or different fill volumes. In a two-container configuration, the ratio of the container volumes is preferably 5:1; in a three-container configuration, preferably 4:1:1, these configurations being particularly suitable for use in automatic dishwashers.

A dosing chamber can be formed in or on a container before the outlet in the direction of flow of the product. The dosing chamber determines the amount of product to be released from the container into the surroundings. In one aspect the dosing unit dispenser that releases the product from the container into the surroundings may only operates in a release position and a closed position, without controlling the released quantity. The dosing chamber then provides a predefined quantity of product to be released, without a direct feedback of the quantity of dispensed product.

The dosing chamber can be integral with the container, or can be in a plurality of parts.

By making the dosing chamber integral with the container, a cost effective production of container and dosing chamber is achieved in an integral production step.

However, there are conceivable applications in which a simple and variable regulation of different dosing ratios for the various preparations is desired. In this case it is advantageous to form the dosing chamber and container as separate parts.

According to another advantageous embodiment of the invention, one or more containers can have liquid-tight closable container openings. This closable container opening allows, for example, refilling of the product stored in this container.

However, a consumer may consider refilling a container to be an inconvenience. Therefore, in order to still have multiple use of the control unit, the control unit can be detachably connected with one or more of the containers. In this case, snap-in or push-fit connections are particularly preferred.

The volume ratio of the constructed volume of the dosing device to the filling volume (capacity) of the container is preferably <1, particularly preferably <0.1, in particular preferably <0.05. This ensures that, for a predefined total volume of the dosing device and container, the major fraction of the constructed volume is utilized by the container and the preparation contained therein.

The container usually has a filling volume (capacity) of <5000 ml, in particular <1000 ml, preferably <500 ml, particularly preferably <250 ml, quite particularly preferably <50 ml.

The dosing unit can assume any shape. For example it can be in the shape of a cube, a sphere or a disc.

In particular, the dosing unit can be matched to the geometries of the appliances on which or in which it is used, thereby minimizing the loss of useful volume.

When using the dosing unit in automatic dishwashers, it is particularly advantageous to shape the dosing unit according to the tableware to be cleaned in the automatic dishwasher. Thus, the dosing unit can be designed, for example, in the shape of a disc having the approximate dimensions of a plate. In this way the dosing unit can be positioned in the lower basket to save space. Moreover, due to the plate-like shape, the consumer can intuitively position the dosing unit correctly.

From the same considerations, it is also conceivable to make the dosing unit in the shape of a beaker.

In order to provide a direct visual control of the fill-level, the container is advantageously made, at least in part, of a transparent material.

In order to protect heat-sensitive ingredients of a product in a container against heat, the container is advantageously manufactured from a material with a low thermal conductivity.

Another possibility for diminishing the action of heat on a product in the container is to insulate the container by suitable means, for example, by using heat insulating material such as Styropor® expandable polystyrene (from BASF), which suitably encloses the container either completely or partially.

Another way of protecting heat-sensitive substances in a container is, if there is a plurality of containers, according to their respective locations.

Thus, for example, it is conceivable to partially or completely enclose a container containing heat-sensitive material in at least one other container filled with a product, the product and other container acting as a thermal insulator for the enclosed container. This means that a first container that contains the heat-sensitive material is partially or completely enclosed in at least one other container that is filled with a product, wherein as the surroundings heat up, the heat-sensitive product in the first container exhibits a slower increase in temperature than the product(s) in the surrounding container(s).

In order to bring about a further improvement in the thermal insulation when two or more containers are used, the containers can be positioned relative to each other according to the Matroschka Principle (nested layers), such that a multi-layer insulation layer is formed.

In particular, it is advantageous that at least one product stored in a surrounding container has a thermal conductivity between 0.01 and 5 W/m*K, preferably between 0.02 and 2 W/m*K, particularly preferably between 0.024 and 1 W/m*K.

The invention is particularly suitable for dimensionally stable containers such as beakers, cans, cylinders, cartridges, bottles, canisters, pots, boxes, drums or tubes; however, it can also be used for flexible receptacles such as bags or sacks, in particular, when they are used according to the bag-in-box principle.

In a preferred embodiment of the invention, the container has an RFID-tag that at least has information about the contents of the container and which can be read by the sensor unit.

This information can be used to select a dosing program stored in the control unit. This ensures that a dosing program optimized for a particular preparation is always used. In the absence of an RFID-label or with an RFID-label with false or incorrect recognition, it can be designed so that the dosing device does not dose, but instead emits an optical or acoustic signal to inform the consumer of the fault.

In order to avoid any misuse of the container, the containers can also possess structural elements that cooperate according to a lock and key principle with the corresponding elements of the dosing appliance, whereby only containers of a particular type can be mounted on the dosing appliance. Moreover, this design ensures that information concerning the containers mounted on the dosing appliance is communicated to the control unit, thereby enabling a coordinated control of the dosing device according to the content of the corresponding container.

The outlets of the container which can be coupled with one or more dispensers for the controlled release of product are preferably arranged in a line, thereby enabling a slim, plate-shaped design of the dosing dispenser.

For a pot-shaped or beaker-shaped design of the container or their pot-shaped or beaker-shaped grouping, it can however also be advantageous to arrange the release openings of the container in a circular arc.

### Sensor

In the context of this application, a sensor is defined as a measurement recorder or measurement probe that can qualitatively or quantitatively measure specific physical or chemical properties and/or the material properties and condition of its surroundings as a measured quantity.

The dosing unit possesses at least one sensor that can determine the physical, chemical and/or mechanical parameters of the surroundings of the dosing unit. The sensor unit can include one or more active and/or passive sensors for qualitative and/or quantitative measurement of mechanical, electrical, physical and/or chemical quantities fed to the control unit as control signals.

In particular, sensors of the sensor unit can include timers, temperature sensors, infrared sensors, luminosity sensors, movement sensors, elongation sensors, rotational speed sensors, proximity sensors, flow sensors, color sensors, gas sensors, vibration sensors, pressure sensors, conductivity sensors, turbidity sensors, sound pressure sensors, lab-on-a-chip sensors, force sensors, acceleration sensors, tilt sensors, pH sensors, moisture sensors, magnetic field sensors, RFID sensors, resonance sensors, biochips, odor sensors, hydrogen sulfide sensors and/or MEMS sensors.

For those preparations whose viscosity is strongly temperature dependent, it is advantageous to provide flow sensors in the dosing device to control the volume and mass of the dosed preparations. Suitable flow meters can include differential pressure flow meters, magnetically inductive flow meters, mass flow measurements according to the Coriolis method, vortex flow measurement methods, ultrasound flow measurement methods, buoyancy flow measurement, ring piston flow measurement, thermal mass flow measurement and/or differential pressure flow measurement.

A temperature dependent viscosity curve of at least one preparation can also be stored in the control unit, wherein dosing is regulated by the control unit as a function of temperature, and therefore, the viscosity of the preparation.

In a further embodiment of the invention, a device is provided for directly measuring the viscosity of the preparation.

The abovementioned alternatives for determining the dosed amount or viscosity of a preparation can produce a control signal processed by the control unit, thereby controlling a dispenser that results in an essentially constant dosing of a preparation.

The data transfer between sensor and control unit can be made through an electric cable or wirelessly.

A wireless data transfer can be performed by the transfer of electromagnetic waves. The wireless data transfer is preferably made according to recognized standards such as for example Bluetooth, IrDA, IEEE 802, GSM, UMTS etc.

### Energy Source

In the context of this application, an energy source is defined as a constructional element of the dosing device that supplies energy appropriate for the independent operation of the dosing device.

The energy source preferably makes electrical energy available. The energy source can include, for example, a battery, a power supply unit, solar cells or the like.

It is advantageous that the energy source is replaceable, for example in the form of an exchangeable battery.

However, it is also conceivable to furnish mechanical energy sources consisting of one or more coil springs, torsion springs or torsion bar springs, spiral springs, pneumatic springs/gas pressure springs and/or elastomeric springs.

In particular, batteries and accumulators are provided as the energy source.

A battery can include, for example, alkali metal manganese batteries, zinc graphite batteries, nickel oxyhydroxide batteries, lithium batteries, lithium iron sulfide batteries, zinc air batteries, zinc chloride batteries, mercury oxide zinc batteries and/or silver oxide zinc batteries.

Exemplary suitable accumulators are lead accumulators (lead dioxide/lead), nickel cadmium accumulators, nickel metal hydride accumulators, lithium ion accumulators, lithium polymer accumulators, alkali metal manganese accumulators, silver zinc accumulators, nickel hydrogen accumulators, zinc bromine accumulators, sodium nickel chloride accumulators and/or nickel iron accumulators.

The accumulator can be designed such that it can be recharged by induction.

Moreover, devices for converting energy which produce a voltage, by which the accumulator is charged, can be provided in or on the dosing unit. For example, this can be a dynamo that is driven by water flowing during a cleaning cycle in an automatic dishwasher and delivers the thus-produced current to the accumulator.

### Control Unit

In the context of this application, a control unit is defined as a device suitable for influencing material transport, energy and/or data. The control unit may influence accumulators with the help of data processed according to the scope of the control objective.

In one aspect, the control unit can be a programmable microprocessor. In a particularly preferred embodiment of the invention, a plurality of dosing programs which are selectable and executable according to the containers connected to the dosing appliance is stored on the microprocessor.

In a preferred embodiment, the control unit is not linked to the controls of the domestic appliance. Therefore, no data such as electrical or electromagnetic signals are directly exchanged between the control unit and the control of the domestic appliance.

In an alternative embodiment of the invention, the control unit is connected to the existing control of the domestic appliance. This connection is preferably a wireless connection. For example, it is possible to place a sensor on or in an automatic dishwasher, preferably above or on the dosing chamber recessed in the door of the automatic dishwasher, which sends a wireless signal to the dosing unit when the controller of the domestic appliance actuates the dosing, for example, a cleaning agent or rinsing agent from the dosing chamber.

Frequently, magnetic actuators trigger these types of dosing chamber in automatic dishwashers so that the dosing chamber is opened, for example, by a Hall sensor.

A plurality of programs can be stored in the control unit for the release of different preparations or for the release of products in various applications.

The call for the appropriate program occurs, for example, as described previously, by the corresponding RFID label or molded geometrical information carriers on the container. Consequently, it is possible to use the same control unit for a plurality of applications, such as for dosing cleaning agents in automatic dishwashers, dispensing perfumes when fragrancing rooms, applying cleaning substances into a toilet bowl, etc.

For dosing preparations that tend to gel, the control unit can be configured such that the dosing is made in a sufficiently short time in order to ensure a good cleaning result, yet not dosed so fast that gelification of the preparation flush occurs. This can be realized, for example, by a staged release, wherein the individual dosing intervals are set such that the correspondingly dosed quantity completely dissolves during a cleaning cycle.

### Actuator

In the context of this application, an actuator is defined as a device that converts one entry quantity into another type of exit quantity and with which an object moves or is moved, wherein the actuator is connected with at least one dispenser that can actuate, directly or indirectly, the release of product from at least one of the containers.

The actuator can be powered by drives such as gravity drives, ionic drives, electric drives, motor drives, hydraulic drives, pneumatic drives, gear wheel drives, threaded spindle drives, ball screw drives, linear drives, roller screw drives, tooth worm drives, piezoelectric drives, chain drives, and/or reaction drives.

In one aspect, the actuator can be designed from an electric motor coupled to a gear that converts the rotational movement of the motor into a linear movement of a slide coupled to the gear. This is particularly advantageous for a slim, plate-shaped design of the dosing unit.

At least one magnet element can be arranged on the actuator that, with a homopolar magnet element on the dispenser, causes a release of product from the container as soon as both magnet elements are located opposite one another, thereby causing a magnetic repulsion and producing a contactless release mechanism.

The above-described slide or magnet element for operating the dispenser is preferably located between the container openings for a configuration of the dosing elements having two containers in the off or start position. By this means the dispenser can be operated solely by the change in the drive direction.

### Dispenser

In the context of this application, a dispenser is defined as a component operated by an actuator and, due to this action, causes the product release outlet of the container to open or close.

The dispenser can be, for example, valves, which can be brought into a product release (open) position or a closed position by the actuator.

A particularly preferred embodiment of the dispenser and the actuator is that of a magnetic valve wherein the dispenser and the actuator are respectively formed by the valve and the electromagnetic or piezoelectric drive of the magnetic valve. When a plurality of containers and hence dosed substances are involved, the use of magnetic valves enables the quantity as well as the dosing time to be accurately regulated.

Consequently, it is advantageous to control the release of product from each product outlet of a container with a magnetic valve, in that the magnetic valve directly or indirectly determines the release of product from the product outlet.

### Indicator

In the context of this application, an indicator is defined as an element capable of displaying to a consumer in a visual, acoustic and/or haptic manner, the attainment of or deviation from certain physical, chemical, electrical or mechanical states in the dosing device or its surroundings. The indicator may be located on the dosing device.

For example, an indicator can in the form of a lamp, such as an LED, or an acoustic signaling device for monitoring the voltage of a battery.

Moreover, it is advantageous to provide an indicator for monitoring the filling level of the container, especially when the container is opaque.

The release and dosing device according to the invention is particularly suitable for use in an automatic dishwasher. However, it is also conceivable to use the release and dosing unit in any other application wherein a controlled release of active substance is desired, such as, for example in washing machines, washer dryers, fragrance release devices, WC-cleaning and/or disinfection devices, or the like.

The invention is illustrated below in more detail with reference to the illustrative drawings. Particularly preferred developments and particularly preferred combinations of characterizing features will also be described below in detail.

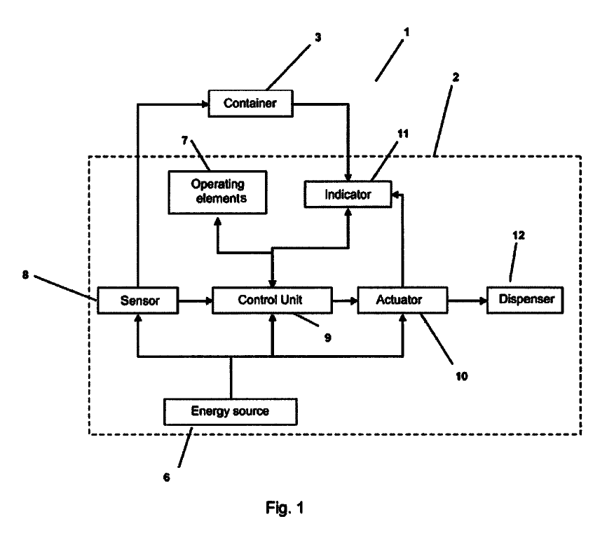

FIG. 1 shows a schematic block diagram of the dosing unit 1. The dosing unit 1 consists of a control module 2 as well as a container 3 that can be connected to the control module 2. At least one energy source 6, optionally one or more operating controls 7, at least one sensor 8, a control unit 9, an actuator 10, optionally an indicator 11, and a dispenser 12 are located inside the control module 2.

The control module 2 is enclosed in a housing having an interior protected from the ingress of moisture.

The sensor 8 can be connected with the control unit 9. Depending on the type of sensor 8, it can be supplied with energy from the energy source 6 required to operate the sensor 8. The signals from the sensor 8 are transmitted to the control unit 9.

The control unit 9 is preferably designed as a programmable microprocessor and may possess various callable programs made up of sensor data variables that are routed to the actuator 10. The control unit 9 is powered with electrical voltage by the energy source 6, which can be, for example, a battery or accumulator.

The actuator 10 can be controlled by the control unit 9 and converts control signals from the control unit 9 into a movement that actuates the dispenser 12 for either release of product from the container 3 or for closing the container 3. Energy required for this can be received by the actuator 10 from the energy source 6.

For monitoring the operating state of the control module 2, the actuator 10 and/or the control unit 9 can be connected to an indicator 11. The indicator 11 depicts the operating status of the control module 2 by an optical, acoustic or other perceptible means

The control module 2 can be operated or controlled by an operator with one or more operating elements 7. The operating elements 7 can be designed for example as a program selector switch for choosing an appropriate control program in the control unit 9 or as an on/off switch for the control module 2.

For monitoring the operating state of the control module 2, the actuator 10 and/or the control unit 9 can be connected to an indicator 11. The indicator 11 depicts the operating status of the control module 2 by an optical, acoustic or other perceptible means

The control module 2 can be operated or controlled by an operator with one or more operating elements 7. The operating elements 7 can be designed for example as a program selector switch for choosing an appropriate control program in the control unit 9 or as an on/off switch for the control module 2.

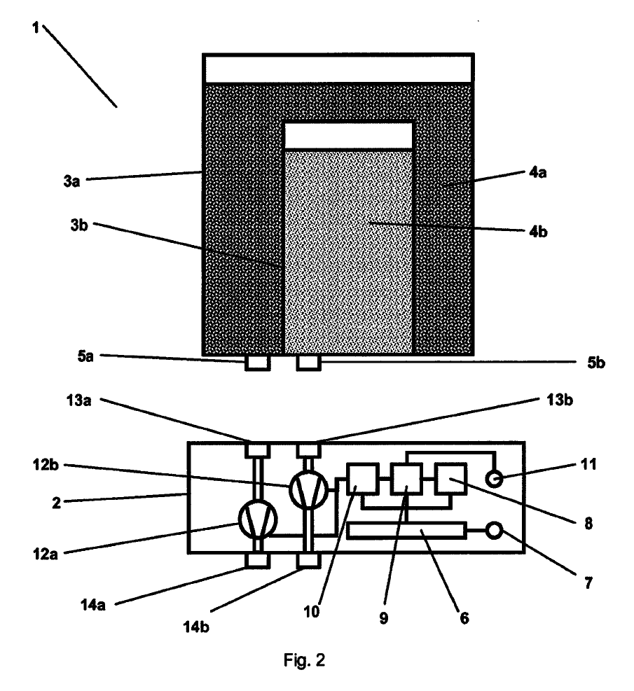

FIG. 2 shows a cross sectional view of the dosing unit 1 consisting of a container 3 and control module 2. In the embodiment illustrated in FIG. 2 the container 3 is made up of two single containers 3a and 3b. The inner container 3b is enclosed by the outer container 3a. Inside the container 3b is a product 4b that may be more heat-sensitive than the product 4a in the outer container 4b.

By this configuration, the outer container 3a together with its preparation 4a stored therein forms an insulation layer that protects the inner container 3b from thermal effects. At the bottom, both containers 3a and 3b possess an outlet 5a and 5b. The bottom configuration of the outlets 5a and 5b allows, for example, gravity-activated release of the products 4a and 4b from the containers 3a and 3b.

The outlets 5a and 5b of the container 3 can be coupled to the inlets 13a and 13b of the control module 2. The outlets 5a and 5b and inlets 13a and 13b are configured such that a liquid-tight joint is formed between the outlets, thereby preventing an unintentional leakage of products 4a and 4b from the container 3 coupled to the control module 2.

Moreover, the outlet 5a, 5b and inlet 13a, 13b can include a device that opens tamper-evident closures (not shown) located on the outlets 5a, 5b when the container 3 is first inserted into the control module 2. Furthermore, snap-in, push-fit or plug-in connections can be designed to secure the container 3 in the control module 2.

An energy source 6 is located inside the control module 2. The energy source 6 can be, for example, an electrical source such as a battery or accumulator. The energy source 6 can be connected to the sensor 8, the control unit 9 and the actuator 10, and supplies electrical voltage to these components. The voltage supplied from the energy source 6 to the electrical consuming equipment can be interrupted by the operating element 7.

The sensor 8 can be connected to the control unit 9, and the control unit 9 can be in connection with the actuator 10. The actuator 10 can be connected to the dispensers 12a, 12b. As FIG. 2 shows, the dispensers 12a, 12b can be designed as pump elements, for example, in the form of micro-dosing pumps or magnetic valves.

Product release from the containers 3a, 3b occurs from the dispensers 12a, 12b actuated by the control unit 9. The products 4a, 4b are released from the outlets 14a, 14b into the surroundings when the dispensers 12a, 12b are in the release position.

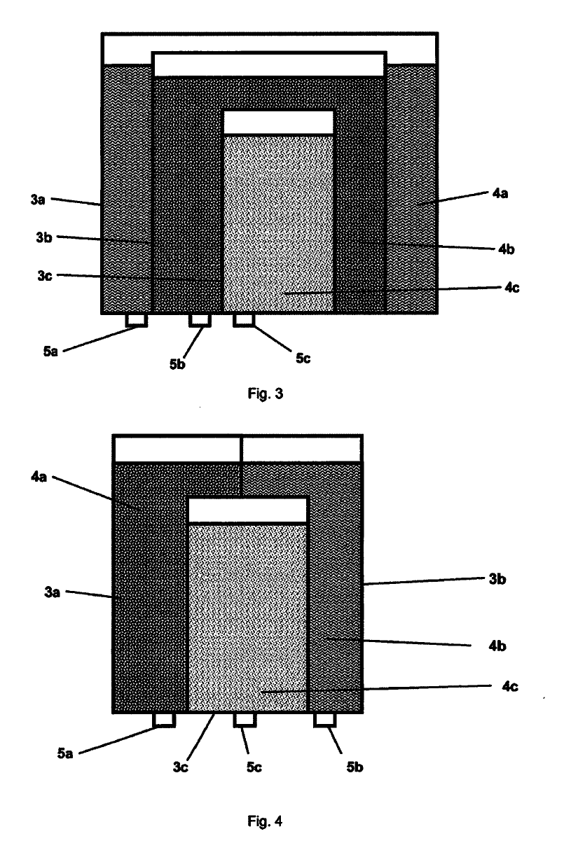

FIG. 3 shows another embodiment of the container 3. The inner container 3c is enclosed by a second container 3b, wherein the second container itself is again enclosed by an outer container 3a. The containers 3a, 3b, 3c are thus arranged as nestable containers analogous to the Matroschka Principle. In this arrangement, heat-sensitive product 4c can be stored in the inner container 3c. The outer containers 3a, 3b can be at least partially filled with product 4a, 4b, respectively, that serve as heat insulation. The product outlets 5a, 5b, 5c are arranged on the bottom of the container.

Another embodiment of the invention is depicted in FIG. 4. Here, the inner container 3c is enclosed by the containers 3a and 3b depicted as L-shaped in the cross sectional profile. The outer containers 3a, 3b are fixed together by suitably chosen fixing means. For example, the container arrangement can be held together by means of a sleeve.

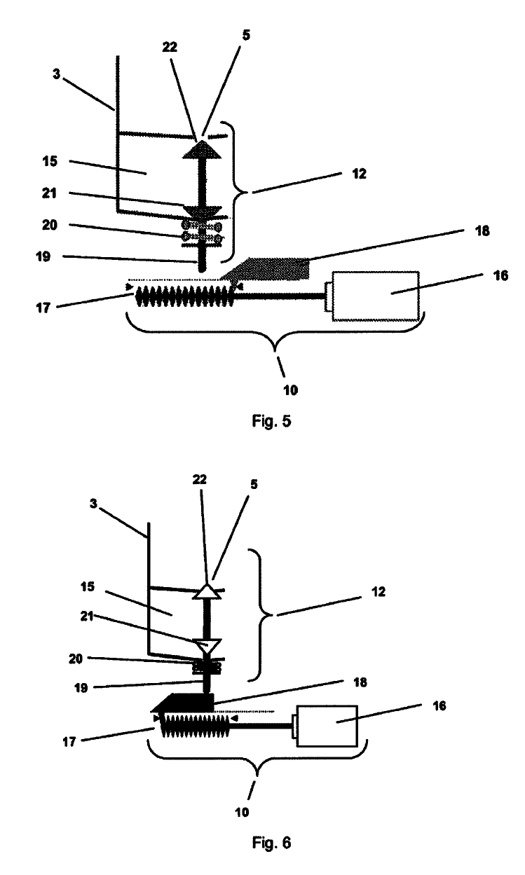

A release mechanism for releasing product from the container 3 into the surroundings is depicted in FIG. 5. The release mechanism includes an actuator 10 and dispenser 12. The actuator 10 comprises a bi-directionally rotating motor 16 that is coupled to a gear 17. The gear 17 can be, for example, a worm gear onto which the slide 18 is coupled. The slide 18 can move backwards and forwards linearly and parallel to the engine axis by the rotational movement of the motor 16 transmitted to the worm drive 17.

The dispenser 12 includes a piston 19 having a first sealing element 22 located on its upper end. Spaced apart therefrom is a second sealing element 21 fixed on the piston rod. In the closed position of the dispenser 12 illustrated in FIG. 5, the sealing element 21 tightly seals the product outlet of the container 3, while the sealing element 22 uncovers the inlet 5 so that product can flow out of the container 3 into the dosing chamber 15 arranged underneath. The tight press fit of the sealing element 21 in this closed position is produced by a spring element 20.

In the release position of the dispenser 12 illustrated in FIG. 6, the slide 18 of the actuator is positioned below the piston and lifts it upwards against the spring force of the spring element 20, such that the sealing element 22 seals the inlet 5, thereby preventing a dripping of product from the container 3 into the dosing chamber 15, and the sealing element 21 uncovers the product outlet so as to release product into the surroundings.

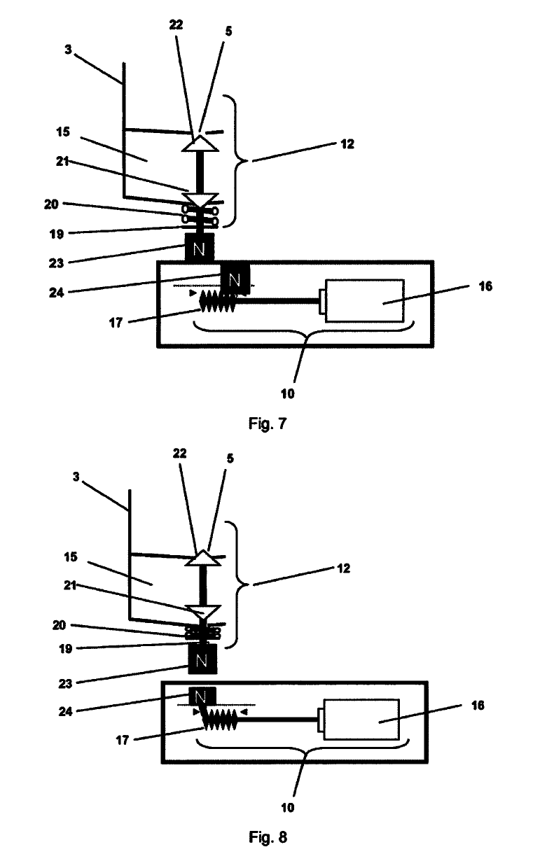

Another possible embodiment of a product release mechanism is shown in FIG. 7 and FIG. 8. Here the actuator 10 possesses a magnetic element 24 instead of a slide 18, with the actuator 10 being completely enclosed in a housing. A homopolar magnetic element 23 is arranged on the piston 19 of the dispenser 12. Both magnetic elements 23 and 24 are configured such that the piston rod 19 is pressed against the spring force of the spring element 20 with the sealing element 22 tightly against the outlet 5 when the magnetic element 24 is moved by the gear 17 to a position underneath the magnetic element 23. This magnetic cooperation of the actuator 10 and dispenser 12 allows a contact-free operative connection of both of these components to be made and to completely enclose the actuator 10, for example, in a liquid-tight manner in a housing.

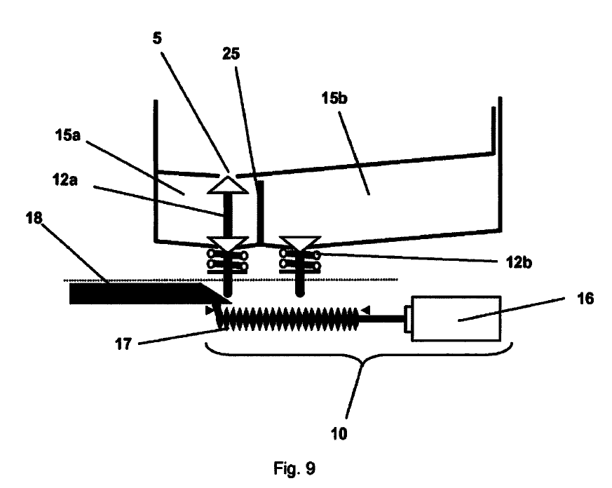

Another embodiment of the invention is shown in FIG. 9. Here the wall 25 divides the dosing chamber 15 into two dosing chamber sections 15a and 15b. A first dispensing assembly 12 is arranged in the first dosing chamber section 15a. In the closed position shown in FIG. 9, the inlet 5 is uncovered and the outlet of the dosing chamber 15a is sealed by the first dispensing element 12a.

In this position product flows out of the container 3 through the inlet 5 into the first dosing chamber section 15a. After exceeding the height of a fill level corresponding to the height of the wall 25, the product then flows into the dosing chamber 15b. Consequently, at the end of this process both chambers 15a and 15b are filled with product.

If a slide 18 is moved by the gear assembly 17 under the first dispenser assembly 12a bringing the dispenser 12a into a product release position, then product flows out of the dosing chamber section 15a into the surroundings. The dosing chamber section 15b then remains full of product. If the slide 18 is then also moved further under the dispensing assembly 12b bringing it into a product release position, then product subsequently flows out of the chamber 15b into the surroundings. This configuration enables a particularly simple delayed release of product from the container 3.

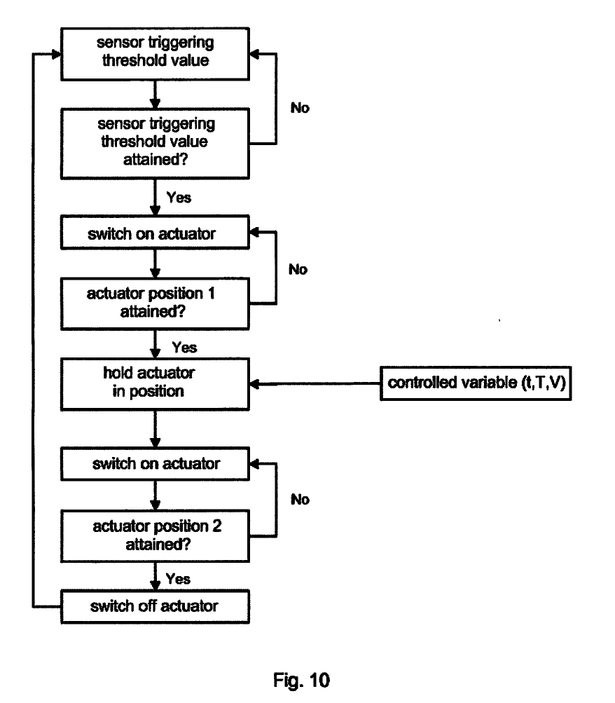

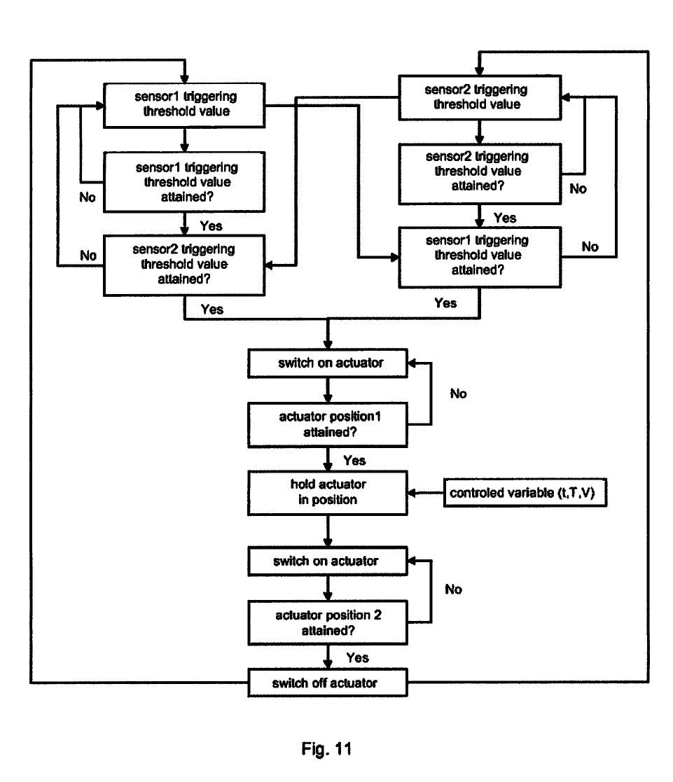

FIG. 10 provides a flow chart for a program executable by the control unit 9. This control sequence is particularly suitable when using a single container 3 and the control unit 9 is connected with only one sensor 8. A sensor release threshold value is stored in the control unit 9. When this value is reached, the control unit 9 produces a signal to switch on the actuator. The actuator 10 remains in the switched on state until a predefined actuator position 1 is reached. In this actuator position 1, the release of product from the container, for example, can be carried out by the dispenser 12. The actuator is held in this position until a predefined quantity such as time, temperature, volumetric flow, etc, is reached. Once this quantity is reached, the actuator is switched on again by the control unit 9 and moved into an actuator position 2. In this actuator position 2, the release of product into the surroundings is prevented by the dispenser 12. A control signal to switch off the actuator is then made by the control unit and a new check made on whether the predefined sensor release threshold value has been attained.

FIG. 11 provides a schematic program control sequence for a configuration of the dosing unit 1 with a container and two different sensors 6 connected with the control unit 9. A first sensor 1 release threshold value and a second sensor 2 release threshold value are stored in the control unit 9. The program control sequence stored in the control unit 9 is configured so that on reaching the first sensor 1 and second sensor 2 release threshold values, a signal to switch on the actuators is produced. The subsequent program control sequence is identical to the program control sequence shown in FIG. 10.

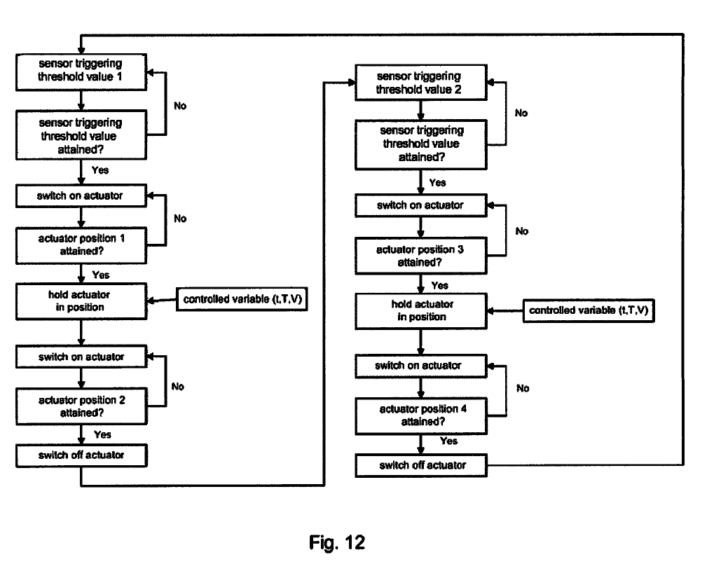

An example of a program control sequence for a dosing unit 1 with two different containers as well as a sensor connected to the control unit is shown in FIG. 12. A first sensor release threshold value 1 and a second sensor release threshold value 2 are stored in the control unit 9. If the first sensor release threshold value 1 is reached, the control unit 9 produces a signal to switch on the actuator 10. The actuator is moved into a first actuator position 1 and held in this position according to a predefined quantity before the actuator is switched on again and moved to a second actuator position 2. If a second sensor release threshold value 2 is reached, the actuator is then moved from the actuator position 2 into an actuator position 3 by a corresponding signal produced from the control unit 9. It will be held there until a predefined quantity is attained. Finally, the actuator is again switched on until it moves into an actuator position 4.

Needless to say, the invention is not limited to the illustrated embodiment. Further developments are possible without leaving the ambit defined in the claims.

We claim:

1. Mobile dispensing and dosing system comprising:
at least two containers for receiving flowable products which differ from one another, wherein the at least two containers each have a dispensing orifice arranged in such a way that a gravity-induced release of product from the respective container occurs in the operational position of the dispensing system,
wherein preparations which are not stable in storage with one another are supplied separately in the at least two containers,
wherein a dosing chamber is formed with at least one container before a dispensing orifice of the dosing system in the flow direction of the product,
wherein the amount of product which is to be freed into the environment on release of product from the at least one container is determined by the dosing chamber,
a control device able to be coupled to the dispensing orifices of the at least two containers, the control device controlling dosing and release of at least the first flowable or dispersible product from the containers into the environment, the control device having
at least one sensor able to detect physical and/or chemical properties and/or the material condition of its environment either qualitatively or quantitatively as a measured variable,
a control unit able to convert signals from the sensor by means of at least one control program stored in the control unit into at least one control signal which can be used for an actuator,
an actuator able to convert a control signal from the control unit into a different type of output variable with which an object is moved or with which movement of the object is induced, the actuator acting indirectly or directly on at least one dispenser, and
at least one energy source able to supply at least the control unit and the actuator with a suitable form of energy,
wherein the at least one dispenser and actuator are solenoid valves.

2. Dispensing and dosing system according to claim 1, wherein at least one of the containers is configured to dispense fragrance into the environment.

3. Dispensing and dosing system according to claim 1, wherein the at least two containers are formed in one piece.

4. Dispensing and dosing system according to claim 1, wherein the at least two containers are formed in multiple pieces.

5. Dispensing and dosing system according to claim 1, wherein the dosing chamber is constructed in one piece with the at least two containers.

6. Dispensing and dosing system according to claim 1, wherein the dosing chamber is constructed in two or multiple pieces with the at least two containers.

7. Dispensing and dosing system according to claim 1, wherein the at least two containers further comprise a first container having a heat-sensitive product, the first container being surrounded at least in part by at least one further container at least partially filled with product(s), wherein the heat-sensitive product in the first container exhibits a slower rise in temperature when the environment is heated than the product(s) in the at least one further container.

8. Dispensing and dosing system according to claim 7, wherein the product(s) in the at least one further container exhibit thermal conductivity of from 0.01 to 5 W/m*K.

9. Dispensing and dosing system according to claim 1, wherein at least one sensor is chosen from timers, temperature sensors, infrared sensors, brightness sensors, temperature sensors, movement sensors, expansion sensors, speed sensors, proximity sensors, flow sensors, color sensors, gas sensors, vibration sensors, pressure sensors, conductivity sensors, turbidity sensors, sound pressure sensors, “lab-on-a-chip” sensors, force sensors, acceleration sensors, gradient sensors, pH sensors, moisture sensors, magnetic field sensors, RFID sensors, magnetic field sensors, Hall-effect sensors, biochips, odor sensors, hydrogen sulfide sensors and/or MEMS sensors.

10. Dispensing and dosing system according to claim 1, wherein the energy source is an electric energy source.

11. Dispensing and dosing system according to claim 1, wherein the control unit further comprises a programmable microprocessor.

12. Dispensing and dosing system according to claim 11, wherein the microprocessor comprises a plurality of dosing programs which can be selected and executed according to the container coupled to the dosing device.

13. Dispensing and dosing system according to claim 1, wherein the control unit is coupled to the existing control unit of the domestic appliance.

14. Dispensing and dosing system according to claim 13, wherein the control unit is coupled wirelessly to the existing control unit of the domestic appliance.
